(19) United States
(12) Patent Application Publication
(10) Pub. No.: US 2007/0043835 A1
(43) Pub. Date: Feb. 22, 2007

(54) State-based workpath system and method

(75) Inventors: Kurt Jung, Beverly Hills, MI (US); Jeremy Cionca, Plymouth, MI (US)

Correspondence Address: HARNESS, DICKEY & PIERCE, P.L.C., P.O. BOX 828, BLOOMFIELD HILLS, MI, 48303, US

(73) Assignee: Oak Adaptive, Inc.

(21) Appl. No.: 11/502,839

(22) Filed: Aug. 11, 2006

Related U.S. Application Data
(60) Provisional application No. 60/709,412, filed on Aug. 18, 2005.

(51) Int. Cl. G06F 15/16

(52) U.S. Cl. 709/219

(57) ABSTRACT

A state-based workpath system comprises a database that stores data relating to existing workpaths. A server executes a server module and communicates with the database. Client computers execute client modules that communicate with the server module and that provide a user interface, allow a first user to initiate a new workpath, display workpath items that are associated with existing workpaths and execute a client script when the first user selects one of the new workpath and the workpath items associated with the existing workpaths. The client script launches a workpath interface that is related to the selected one of the new workpath and the workpath items associated with the existing workpaths. The workpath interface includes input fields and an approval button. The server module transitions the one of the new workpath and the existing workpaths to another state when the first user selects the approval button.

### CROSS-REFERENCE TO RELATED APPLICATIONS

This application claims the benefit of U.S. Provisional Application No. 60/709,412, filed Aug. 18, 2005. The disclosure of the above application is incorporated herein by reference.

### FIELD OF THE INVENTION

The present invention relates to systems and methods for implementing business practices in a company, and more particularly to state-based systems and methods for implementing and enforcing business practices in a company.

### BACKGROUND OF THE INVENTION

Over time, successful companies develop a knowledge base of good business practices. Consistent use of the learned business practices tends to improve efficiency and/or to reduce operating costs. The business practices can also be used to ensure that a customer has a consistent experience when dealing with the company, which is important for increasing repeat business.

Developing good business practices is only part of the problem. Once the business practices are defined, regularly enforcing the business practices over time can be difficult, particularly when the company has high employee turnover. Some companies spend a lot of money developing job descriptions and user manuals that document the operation of the company, the tasks performed by each position and/or the company's best practices and procedures. These descriptions and user manuals are often cumbersome to use and, as a result, may not be used by employees on a regular basis.

### SUMMARY OF THE INVENTION

A state-based workpath system according to the present invention comprises a database that stores data relating to workpaths. A server executes a server module and communicates with the database. Client computers each execute a client module that communicates with the server module, provides a user interface, allows a first user to initiate a new workpath, displays workpath items that are associated with existing workpaths and executes a client script when the first user selects one of the new workpath and the workpath items associated with the existing workpaths. The client script launches a workpath interface that is related to the selected one of the new workpath and the workpath items associated with the existing workpaths. The workpath interface includes input fields and an approval button. The server module transitions the one of the new workpath and the existing workpaths to another state when the first user selects the approval button.

In other features, the workpath items associated with the existing workpaths are arranged by the user interface based on at least one of workpath types and current states. The client script selectively enables the approval button when the input fields of the workpath interface are valid. The server module creates workpath items related to the one of the new workpath and the workpath items associated with the existing workpaths for another user when the first user selects the approval button.

In other features, the client module includes a bootstrap script, a main script and a plurality of the client scripts. The bootstrap script communicates with the server module and selectively updates the main script. The main script selectively updates the client scripts. The server module includes a web server module and a scripting interpreter.

In still other features, the server module identifies the another user by accessing tables stored in the database without input from the first user. When one of the client scripts accesses one of the existing workpaths, the server module locks the existing workpath. The tables store employee reporting relationships. The server module performs an augmented state transition when one of the workpath items associated with the existing workpath transitions to a new state. The client module generates a sign-on screen, the database stores privileges and the server module enables the first user to access selected workpaths based on the privileges granted to the first user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of an exemplary client-server system for implementing a state-based workpath system and method according to the present invention;

FIG. 2 is a functional block diagram illustrating an exemplary software architecture for the state-based workpath system and method according to the present invention;

FIG. 3 is an exemplary screen view of a home page for a user;

FIG. 4 is a state diagram illustrating an exemplary workpath relating to a request for vacation;

FIGS. 5A, 5B and 5C are exemplary tables defining relationships between employees, supervisors and positions;

FIG. 6 is a flowchart illustrating maintenance of client bootstrap, main and individual scripts;

FIG. 7 is a flowchart illustrating steps performed during augmented state transitions between states; and

FIGS. 8A-8F are hybrid flowcharts illustrating the exemplary workpath relating to the request for vacation in further detail.

### DETAILED DESCRIPTION OF THE PREFERRED EMBODIMENTS

The following description of the preferred embodiments is merely exemplary in nature and is in no way intended to limit the invention, its application, or uses. As used herein, the term module refers to an application specific integrated circuit (ASIC), an electronic circuit, a processor (shared, dedicated, and/or group) and memory that execute one or more software and/or firmware programs, a combinational logic circuit, and/or other suitable components that provide the described functionality.

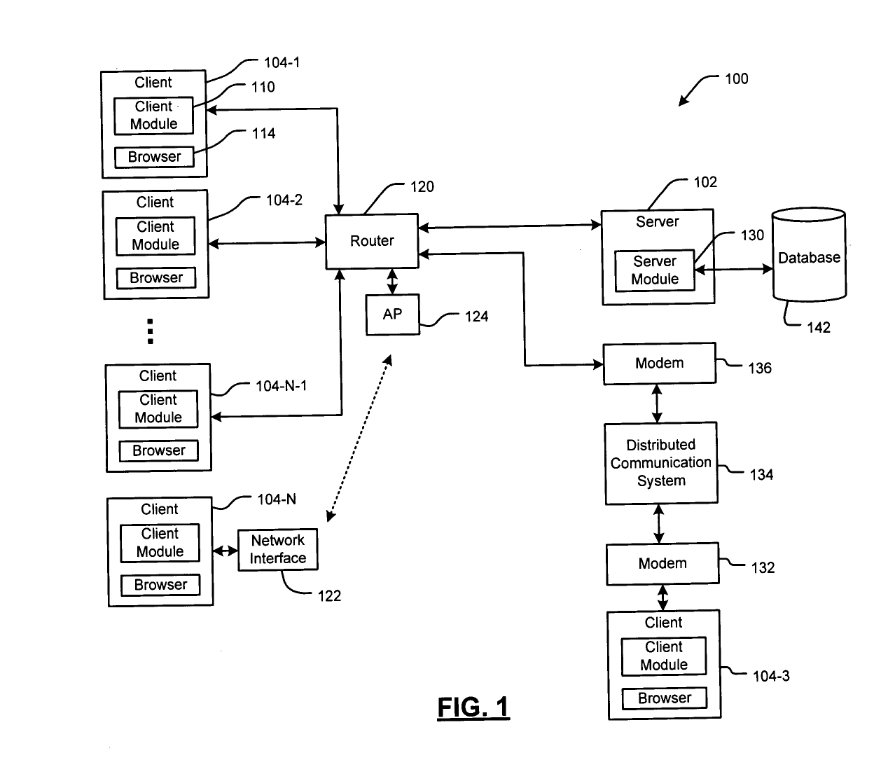

Referring now to FIG. 1, an exemplary client-server system 100 for implementing a state-based workpath system and method according to the present invention is shown. The client server system 100 may employ a thin client approach and includes one or more servers 102 and one or more clients 104-1, 104-2, 104-3 . . . , 104-N-1, and 104-N (collectively clients 104). Each of the clients 104 includes a client module 110 and a browser 114. Any suitable browser can be used. The client module 110 performs thin client functions as will be described further below. In some implementations, the client module 110 forms part of and/or is launched by the browser 114.

The clients 104 may be connected to the server 102 using any suitable approach including both wireless and/or wired connections. For example, the client 104-1 is connected by a router 120 to the server 102. The client 104-N is connected by a network interface 122 to an access point 124, which is connected to the router 120. The client 104-3 is connected by a modem 132 to a distributed communications system (DCS) 134, such as the Internet, an extranet, an intranet, a wide area network (WAN), a local area network (LAN) and/or other system. A modem 136 provides a connection between the router 120 and the DCS 134. Still other connection methods are contemplated between the clients 104 and the servers 102.

The server 102 includes a server module 130 that performs server functions as will be described further below. The server module 130 interfaces with a database 142, which stores data related to workpaths, audit information relating to prior states of workpaths, process flow chains, user profiles, supervisor/position/employee relationships and/or other information as will be described further below. The user profiles may contain information relating to the user's position and/or membership in one or more groups. The groups, in turn, may have different levels of authority.

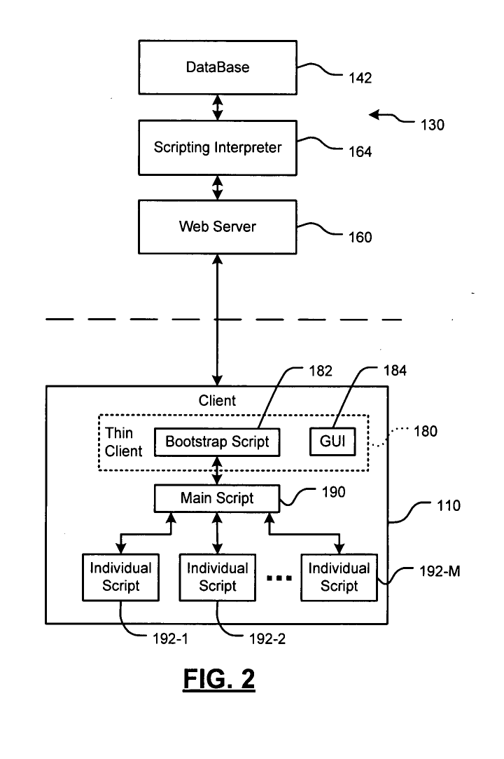

Referring now to FIG. 2, an exemplary software architecture according to the present invention is shown. On the server side, the server module 130 includes a web server 160 that provides an interface between the clients 104 and a scripting interpreter 164. The scripting interpreter 164 implements server scripts that interface with client scripts and with the database 142. In some exemplary implementations, the web server 160 may be a listening server such as Apache or other suitable servers. The scripting interpreter 164 may include a PHP hypertext preprocessor (PHP)-based scripting interpreter, although other scripting interpreters may be used. The database may include a MySQL database, although other types of databases may be used.

The client module 110 comprises a thin client 180 that includes a bootstrap script 182 and graphical user interface (GUI) components 184 such as a basic library of buttons, tools, and windows. The bootstrap script 182 embeds a client scripting interpreter and reads into the client operating system for settings. In addition, the bootstrap script 182 downloads, maintains and/or updates a main script 190. The main script 190, in turn, downloads, maintains and/or updates individual user scripts 192-1, 192-2, . . . , and 192-M (collectively use scripts 192) that are associated with particular workpaths. In some implementations, the main script 190 handles sign-on functions. Some of the user scripts 192 that are downloaded to the client are based on the user's access level that is stored in the database. In some implementations, the client scripting interpreter is a Lua-based scripting language.

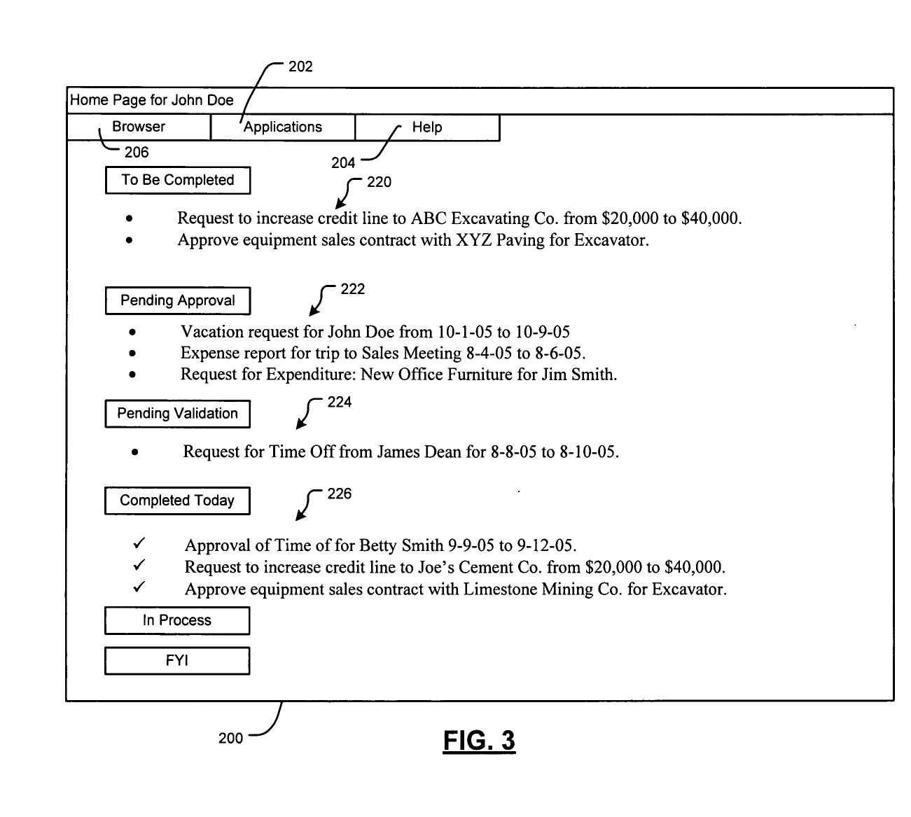

Referring now to FIG. 3, an exemplary screen view of a home page 200 for a user is shown. The home page 200 includes an application menu 202, a help menu 204 and/or other menus 206. The menus may be drop-down menus. One or more workpath types may be launched by the application menu 202. The workpaths populated in the menu 202 may be based on user privileges stored in the database. When the user launches the state-based workpath system, the bootstrap script 182 loads a main script 190. The main script 190, in turn, loads client scripts as needed. A sign-on script with user authentication may be used.

The thin client 180 then loads current workpaths that are relevant to the user. For example, the user has one or more items “To Be Completed” as generally indicated that 220, one or more items “To Be Approved” as indicated that 222, one or more items “Pending Validation” as indicated that 224, and one or more items “Completed Today” as indicated at 226. Each of the items can be a link that is launched by pointing and clicking on the item. Additional categories such as “In Process”, “For Your Information” (FYI), and/or other categories may also be provided and may or may not have items listed.

The items in the “To Be Completed” category may or may not be specific to this user. In other words, there may be one or more persons having the same “To Be Completed” item listed. For example, two supervisors and/or employees may have overlapping responsibility of a process and/or approval item. When the user selects the item by pointing and clicking on the item, a workpath interface is launched that allows the user to provide information to complete the selected item. Once the user selects and opens the item, the workpath associated with the item will be locked until the present user releases the item. Certain other items, such as those in the “Pending Approval” category, may require one particular user to provide authorization. For example, one supervisor may be required to approve vacation requests, expense reports and/or other requests for expenditures.

Once a user selects an item and performs the requested action, the user does not need to address and/or otherwise identify or direct a ToDo item to the email address of a subsequent or approving user. When the user performs an approval action, the server module 130 consults the database 142 and generates ToDo items without input from the user approving the preceding workpath state. This approach provides security in that only the authorized users may access the particular state of the workpath.

The main script 190, the server module 130 and the status of the user also determine whether or not certain applications 202 are available to a particular user. In other words, if an employee is not a supervisor, certain categories such as “Pending Validation” categories may not be provided. In some implementations, these categories are not displayed if they are not available.

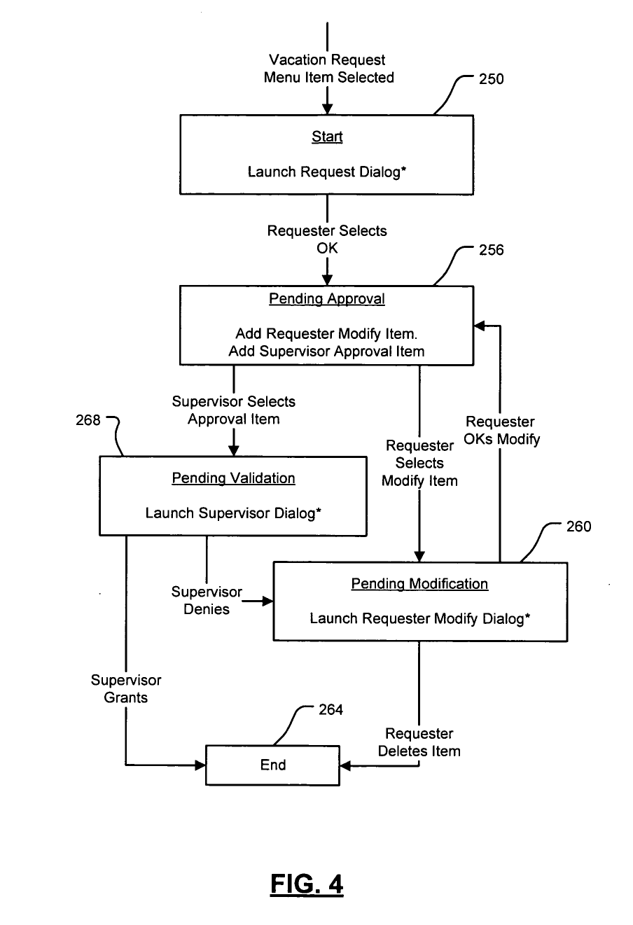

Referring now to FIG. 4, a state diagram illustrating an exemplary state-based workpath relating to a request for vacation is shown. When the user selects a vacation requests from a drop-down menu, the workpath enters a start state at 250. A request workpath interface is launched in the start state 250. When the user completes the information, validation is performed on the data to ensure that the data is correct as will be described further below.

When the workpath interface is complete and valid, the user may accept the vacation request by selecting OK. In some implementations, the approval buttons are disabled until valid data is entered. The workpath for the vacation request transitions to a pending approval state at 256. In the pending approval state 256, the state-based workpath system adds a requester modify item to the page of the requesting user and adds a supervisor approval item to the page of the supervisor of the requester. If the requester selects the item for modification, the workpath transitions to a pending modification state 260 in which a requester modify workpath interface is launched and the workpath is locked. If the requester cancels or deletes the vacation request, the workpath transitions to an end state 264. If the user approves the modifications, the workpath transitions back to the pending approval state 256.

If the supervisor selects the item for approval, the workpath transitions to a pending validation state 268 and a supervisor approval dialog is launched. The workpath is locked. If the supervisor denies the request, the workpath transitions to the pending modification state in step 260. As can be appreciated, the request for vacation is merely exemplary in nature.

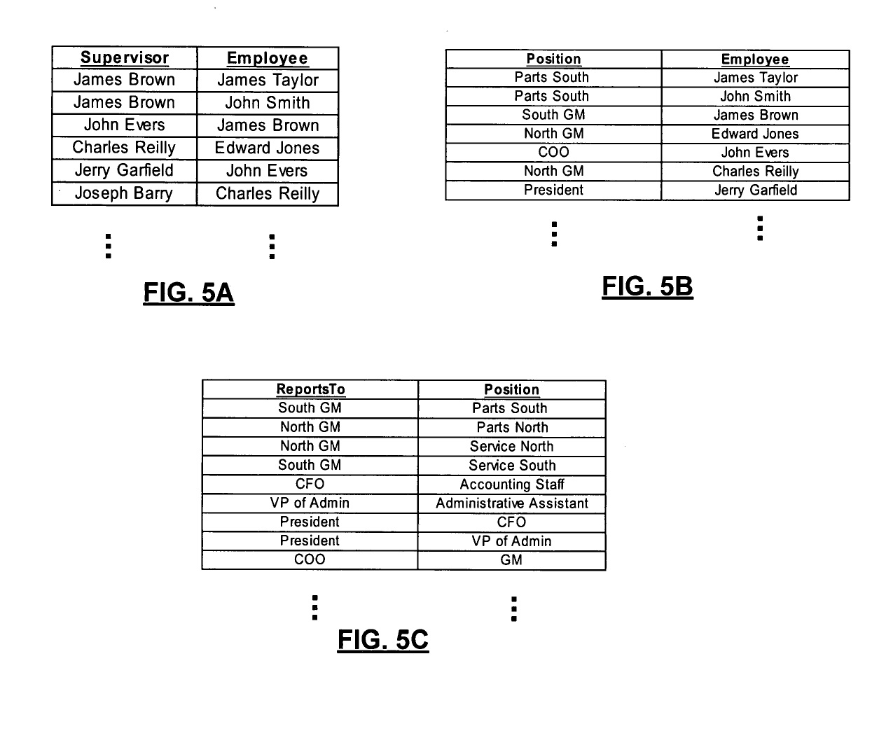

Referring now to FIG. 5A, one or more tables stored in the database define relationships between employees, positions and/or supervisors. Other tables (not shown) specify supervisors, positions and/or employees for approving various stages of business processes such as credit approval, inventory requests, etc. For example, when James Taylor requests time off and submits a request, a ToDo item is generated in the inbox of his supervisor, in this case James Brown. A similar approach can be performed for other processes. For example, in a multi-part process, when a first stage is complete, a table containing other participants in the process is used to identify one or more persons responsible for approval of a subsequent stage. In both circumstances, the initiating user can modify the request until the subsequent user approves and/or otherwise modifies.

Referring now to FIGS. 5B and 5C, multiple tables can be used to identify relationships between employees and their positions in the company and relationships between positions in the company and supervisors (reports to). In FIG. 5B, employees are shown associated with a position in the company. In FIG. 5C, the positions in the company are associated with supervisors having reporting responsibility. As can be appreciated, more than one person may have supervisory authority over an employee. In some implementations, the ToDo item is generated for both supervisors. When one of the supervisors responds to the ToDo item, the ToDo item is removed from both supervisors.

As can be appreciated, by using the tables to define the recipients of the ToDo items, security is improved. In other words, the requester does not have control over where the request is routed. Furthermore, the company's process can be implemented more consistently since it does not rely upon the users to determine where the item should be routed.

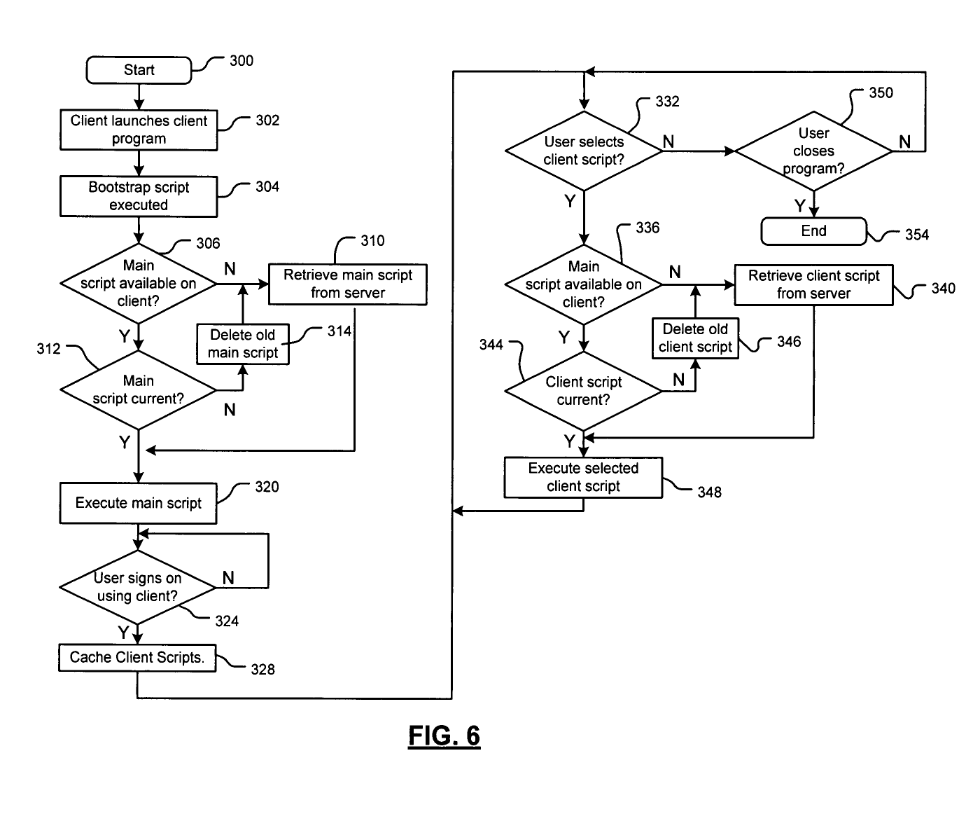

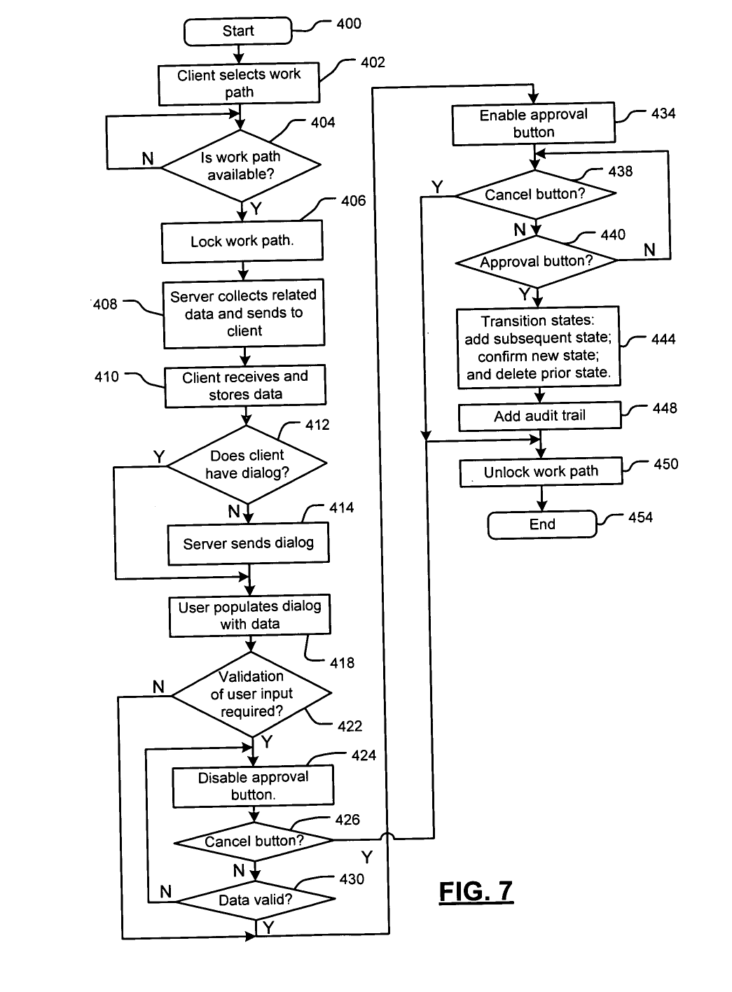

Referring now to FIG. 6, a flowchart illustrating maintenance of bootstrap script 182, the main script 190 and client scripts 192 is shown. Control begins with step 300. In step 302, the client launches the state-based workpath program. In step 304, the bootstrap script 182 is executed in step 304. In step 306, the bootstrap script 182 determines whether the main script 190 is available on the client. If not, the bootstrap script 182 retrieves the main script 190 from the server in step 310. If the main script 190 is available in step 306, the bootstrap script 182 determines whether the main script 190 is current in step 312. If step 312 is false, the bootstrap script 182 deletes the old version of the main script 190 in step 314 and retrieves the main script 190 from the server in step 310.

Control continues from steps 310 and 312 (when true) with step 320 where the main script 190 is executed. When the user signs on in step 324, one or more client scripts 192 are cached in step 328. In step 332, the main script 190 determines whether the user selects a client script. In some implementations, the user selects the client script by selecting a To Do item and/or by selecting an application to launch a new workpath. If step 332 is true, the main script 190 determines whether the client script 192 is available on the client in step 336. If step 336 is false, the main script 190 retrieves the client script 192 from the server in step 340.

If the main script 190 is available in step 336, the main script 190 determines whether the client script 192 is current in step 344. If step 344 is false, the main script 190 deletes the old client script 192 in step 346 and retrieves the client script 192 from the server in step 340. Control continues from steps 340 and 344 (when true) with step 348 where the client script 192 is executed. If step 332 is false, the main script 190 determines whether the user closes the program in step 350. If step 350 is true, control ends in step 354. If step 350 is false, control returns to step 332.

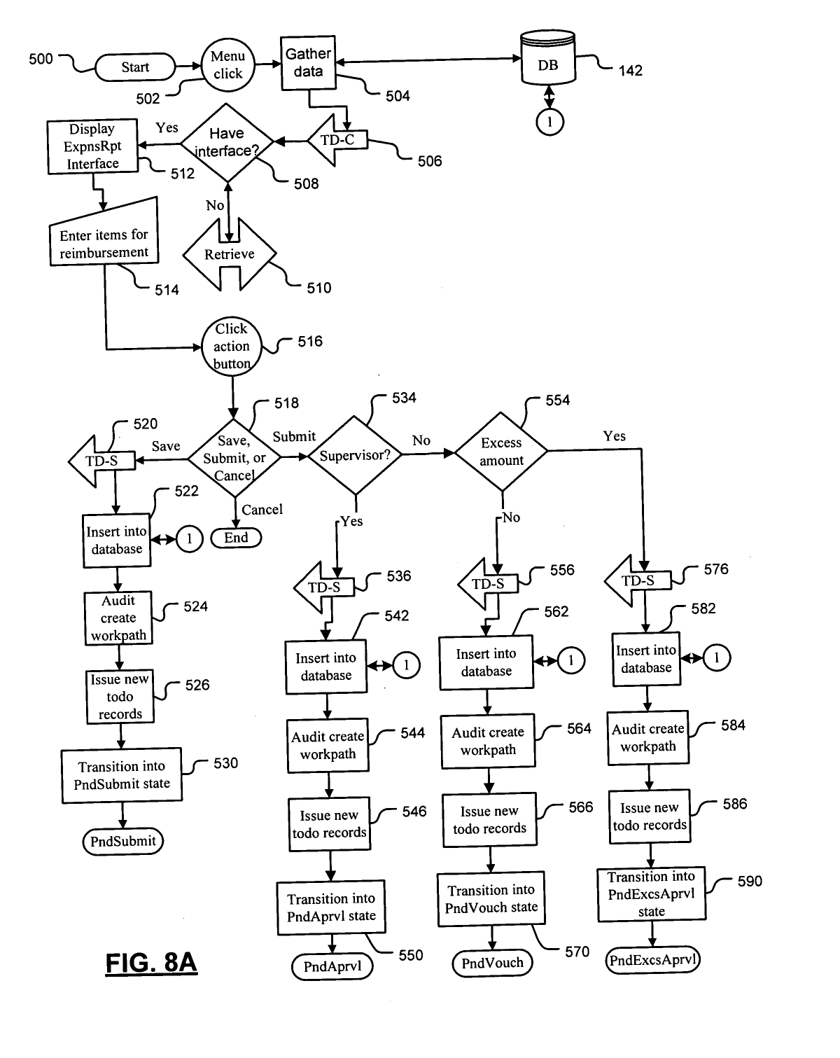

Referring now to FIG. 7, a flowchart illustrating augmented state transitions are shown. Control by the main script 190 begins with step 400. In step 402, the main script 190 monitors when a client selects a workpath (via an item) and determines whether the workpath is locked in step 404. If the workpath is locked, the main script 190 may provide user notification. If the workpath is available, the workpath is locked in step 406. In step 408, the server collects related data and sends the data to the client. In step 410, the client receives and stores the data. In step 412, the main script 190 determines whether the client has a related dialog. If not, the main script instructs the server to send the dialog in step 414.

Control continues from steps 412 (when false) and step 414 with step 418 where the client or user populates the workpath interface with data. In step 422, control determines whether validation of user input is required for the workpath interface. If true, the approval buttons are disabled in step 424. In step 426, control determines whether a cancel button has been selected. If false, control continues with step 430 and determines whether the data is valid. If step 430 is false, control loops back to step 424.

When the data is valid in step 430, the approval button is enabled in step 434. In step 438, control determines whether the cancel button has been selected. If step 438 is false, control determines whether the approval button has been selected in step 440. If step 440 is false, control returns to step 438. If step 440 is true, control continues with step 444 and transitions states. When transitioning states, a subsequent state is preferably added and confirmed before the prior state is deleted. In step 448, an audit trail is added. In step 450, the workpath is unlocked and can be accessed by other users. If the cancel button is selected in step 426 or step 438, control continues with step 450. Control ends in step 454.

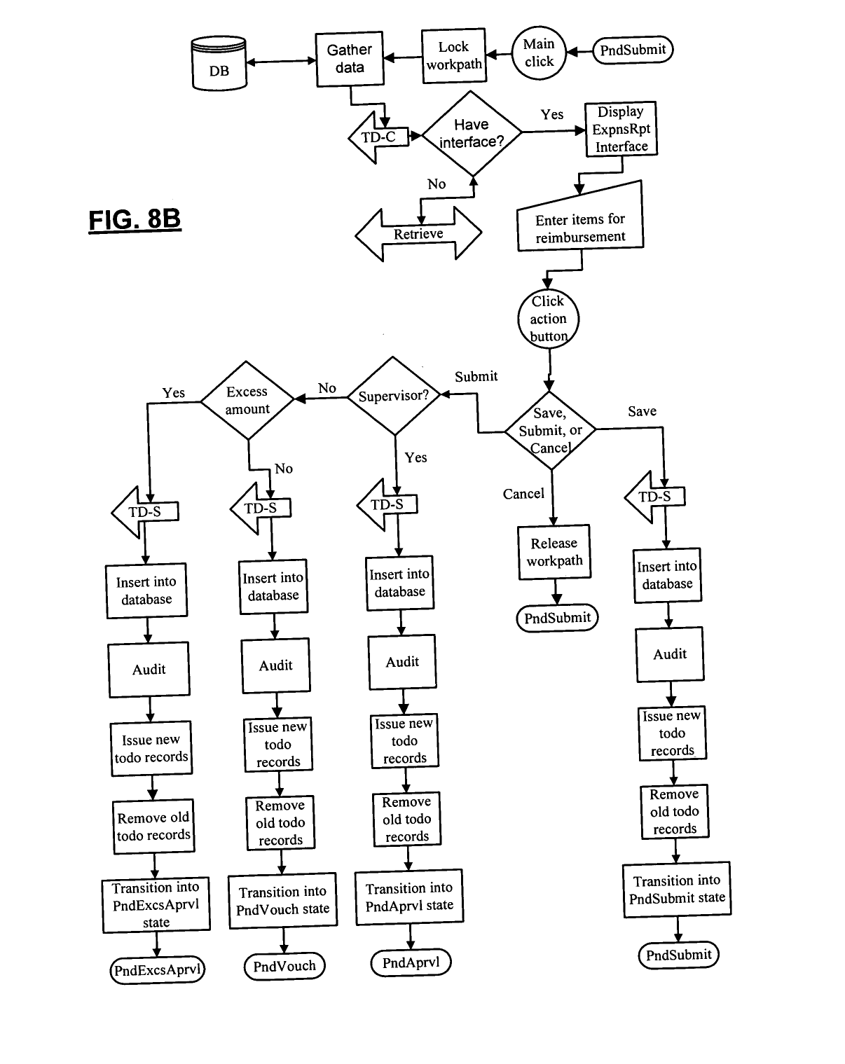

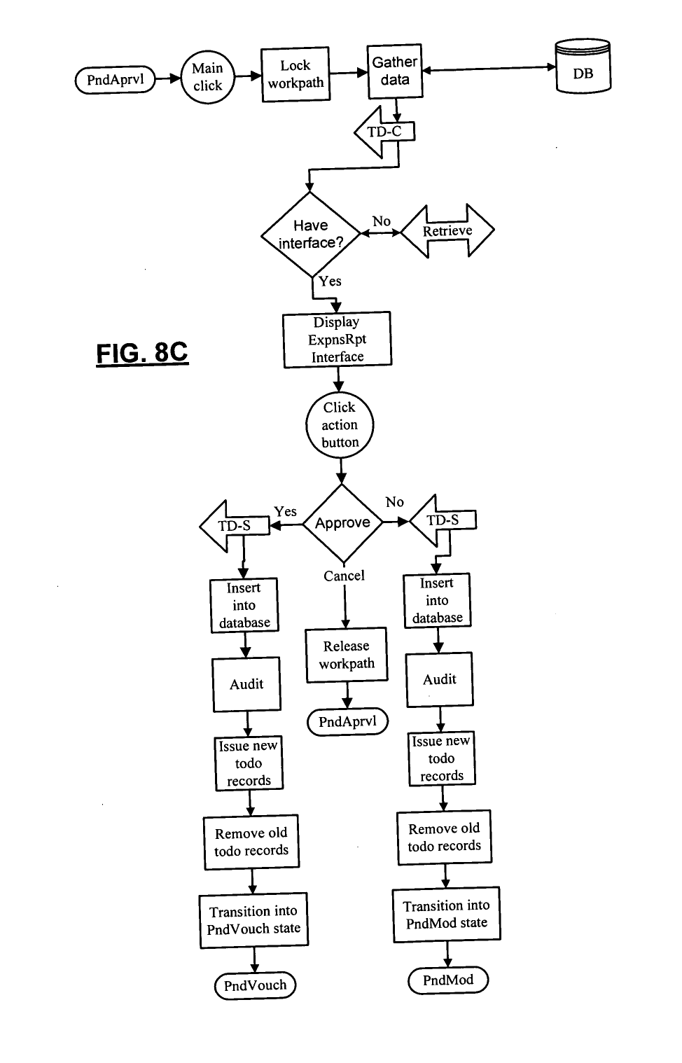

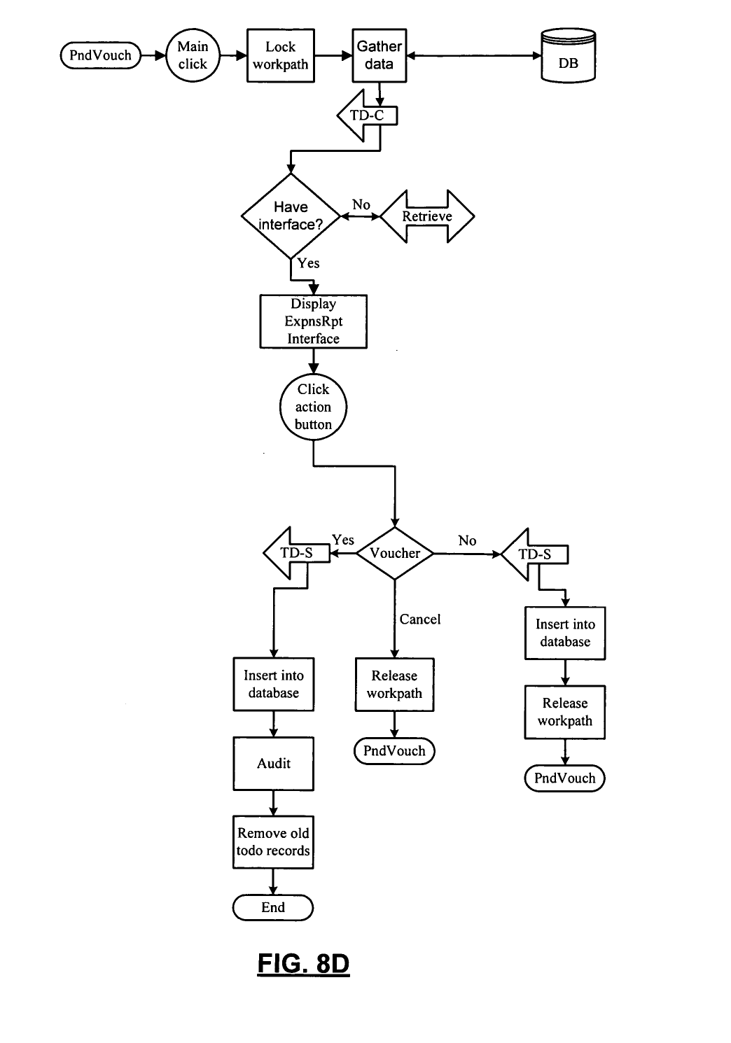

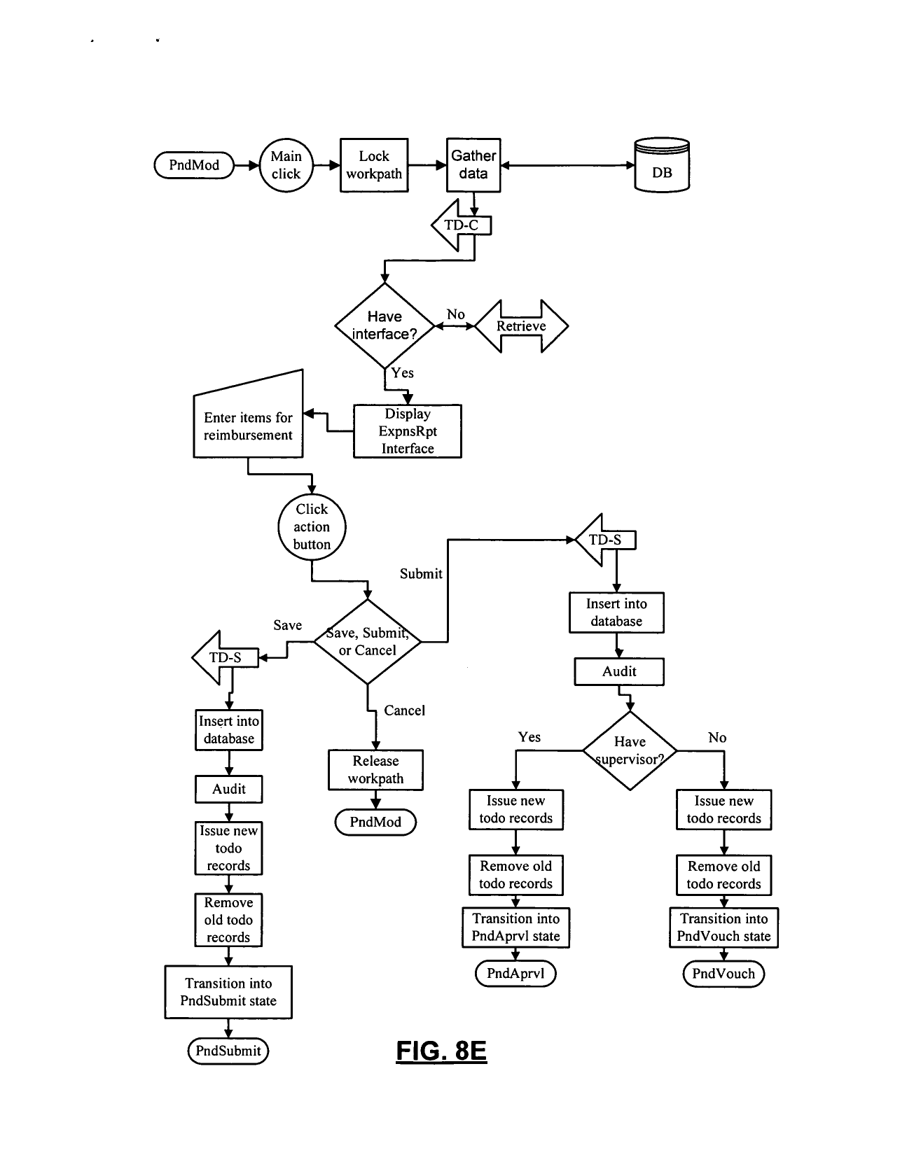

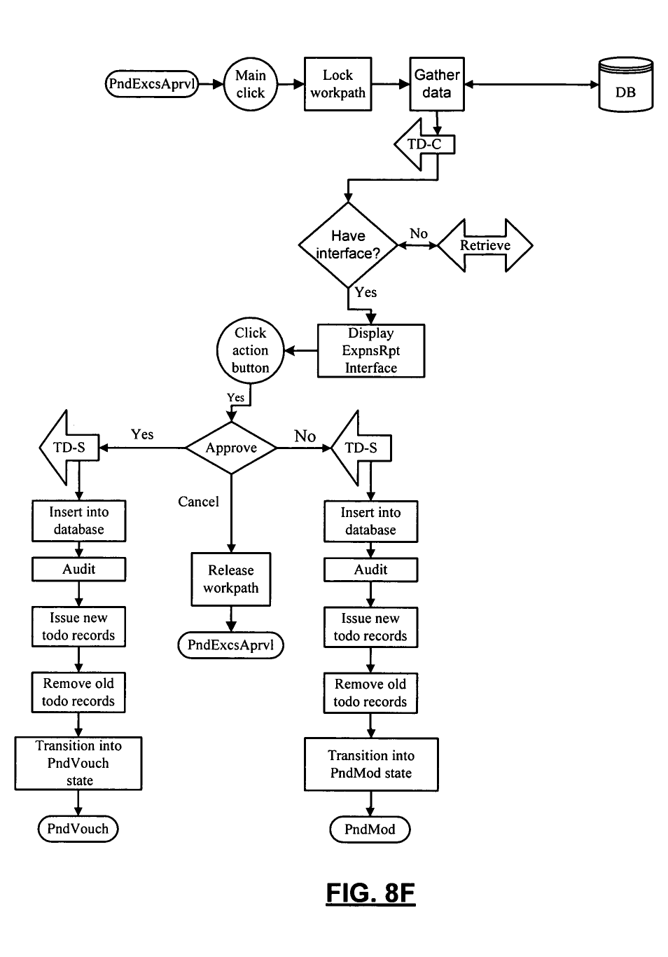

Referring now to FIGS. 8A-8F, hybrid diagrams illustrating the exemplary workpath relating to the request for vacation are shown in further detail. Referring now to FIG. 7A, control begins with step 500 and proceeds to step 502 when a main menu click or item selection occurs for example requesting an expense report. In step 504, data is gathered from the database 142. A transfer of data occurs from the server to the client in step 506. In step 508, the main script 190 determines whether the client has the expense report interface or script 192. If not, the expense report interface or script is retrieved at 510 and control continues with step 512 where the expense report is displayed. In step 514, the user enters items for reimbursement. In step 516, the user clicks an action button such as cancel, save or submit.

If the action button is a save request as determined in step 518, related data is transferred from the client to the server at 520. The data is inserted into the database at 522 and a create workpath audit record is created in step 524. New ToDo records are generated at 526 (in other words, an item is added to a Pending Submission category on the user's screen). The workpath transitions to a pending submit state in step 530.

If the action button is a submit request as determined in step 518, control determines whether the user has a supervisor in step 534. If the user does have a supervisor, data is transferred from the client to the server at 536. The data is inserted into the database at 542 and a create workpath audit record is created in step 544. New ToDo records are generated at 546 (in other words, an item is added to a Pending Approval category on the user's screen and an item is added in the Pending Approval category of the supervisor). The workpath transitions to a pending approval state in step 550.

If the user does not have a supervisor in step 534, control determines whether the amount exceeds a predetermined amount in step 554. If step 554 is false, data is transferred from the client to the server at 556. The data is inserted into the database at 562 and a create workpath audit record is created in step 564. New ToDo records are generated at 566 (in other words, an item is added to a Pending Voucher category of the user). The workpath transitions to a pending voucher state in step 570.

If the amount exceeds a predetermined amount in step 554, data is transferred from the client to the server at 576. The data is inserted into the database at 582 and a create workpath audit record is created in step 584. New ToDo records are generated at 586 (in other words, an item is added to a pending executive approval category of the user and one or more executives). The workpath transitions to a pending executive approval state in step 590.

The remaining FIGS. 8B-8F illustrate each of the remaining states and their logic and work flow. As can be appreciated, while the insert into database steps in FIGS. 8B-8F do not illustrate a connection to the database 142, data flows from the client to the database 142.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A state-based workpath system, comprising:
a database that stores data relating to workpaths and workpath states;
a server that executes a server module and that communicates with said database; and
N client computers each executing a client module that communicates with said server module and that:
provides a user interface;
allows a first user to initiate a new workpath;
displays workpath items that are associated with existing workpaths; and
executes a client script when said first user selects one of said new workpath and said workpath items associated with said existing workpaths,
wherein said client script launches a workpath interface that is related to said selected one of said new workpath and said workpath items associated with said existing workpaths and that includes input fields and an approval button, and
wherein said server module transitions said one of said new workpath and said existing workpaths to another state when said user selects said approval button.

2. The state-based workpath system of claim 1 wherein said workpath items associated with said existing workpaths are displayed by said user interface based on at least one of workpath types and current states.

3. The state-based workpath system of claim 1 wherein said client script selectively enables said approval button when said input fields of said workpath interface are valid.

4. The state-based workpath system of claim 1 wherein said server module creates workpath items related to said one of said new workpath and said workpath items associated with said existing workpaths for another user when said user selects said approval button.

5. The state-based workpath system of claim 1 wherein said client module includes:
a bootstrap script;
a main script; and
a plurality of said client scripts,
wherein said bootstrap script communicates with said server module and selectively updates said main script and wherein said main script selectively updates said client scripts, and
wherein said server module includes a web server module and a scripting interpreter.

6. The state-based workpath system of claim 4 wherein said server module identifies said another user by accessing tables stored in said database without input from said first user.

7. The state-based workpath system of claim 1 wherein when one of said client scripts accesses one of said existing workpaths, said server module locks said existing workpath.

8. The state-based workpath system of claim 6 wherein said tables store employee reporting relationships.

9. The state-based workpath system of claim 1 wherein said server module performs an augmented state transition when one of said workpath items associated with said existing workpath transitions to a new state.

10. The state-based workpath system of claim 1 wherein said client module generates a sign-on screen, said database stores privileges and said server module selectively enables said first user to access selected workpaths based on said privileges granted to said user.

11. A method of providing a state-based workpath system, comprising:
executing a thin client module on client computers;
providing a user interface;
allowing a first user to initiate a new workpath;
displaying workpath items that are associated with existing workpaths using said user interface;
executing a client script when said first user selects one of said new workpath and said workpath items associated with said existing workpaths;
launching a workpath interface using said client script that is related to said selected one of said new workpath and said workpath items associated with said existing workpaths and that includes input fields and an approval button; and
transitioning said one of said new workpath and said existing workpaths to another state when said user selects said approval button.

12. The method of claim 11 further comprising arranging said workpath items associated with said existing workpaths on said user interface based on at least one of workpath types and current states.

13. The method of claim 11 further comprising selectively enabling said approval button when said input fields of said workpath interface are valid.

14. The method of claim 11 further comprising creating workpath items related to said one of said new workpath and said workpath items associated with said existing workpaths for another user when said first user selects said approval button.

15. The method of claim 11 further comprising:
using a bootstrap script to selectively update a main script; and
using a main script to selectively update said client scripts.

16. The method of claim 14 further comprising identifying said another user by accessing tables stored in said database without input from said first user.

17. The method of claim 11 further comprising locking said existing workpath when one of said client scripts accesses one of said existing workpaths.

18. The method of claim 16 wherein said tables store employee reporting relationships.

19. The method of claim 11 further comprising performing an augmented state transition when one of said workpath items associated with said existing workpath transitions to a new state.

20. The method of claim 11 further comprising:
generating a sign-on screen;
selectively enabling said first user access to selected workpaths based on privileges granted to said user.
